(19) United States
(12) Patent Application Publication
(10) Pub. No.: US 2019/0127590 A1
(43) Pub. Date: May 2, 2019

(54) SACCHARIDE-BASED COMPOSITION FOR PROVIDING THERMAL INSULATION AND METHOD OF USE THEREOF

(71) Applicant: VivaVax Inc., Toronto (CA)

(72) Inventors: Qi YANG, Etobicoke (CA); Francis BUGUIS, Toronto (CA)

(21) Appl. No.: 16/177,876

(22) Filed: Nov. 1, 2018

Related U.S. Application Data
(60) Provisional application No. 62/580,550, filed on Nov. 2, 2017.

(51) Int. Cl. C09D 5/00; C09D 1/00; C09D 101/02; C09D 105/00; C09D 101/28; C09D 175/12; F16L 59/00; C03C 17/42

(52) U.S. Cl. CPC C09D 5/00; C09D 1/00; C09D 101/02; C09D 105/00; C09D 101/28; C03C 2218/111; F16L 59/00; C03C 17/42; C03C 2217/212; C03C 2218/32; C09D 175/12

(57) ABSTRACT

A multi-layered composition for externally coating glass and ceramic substrates to provide thermal insulation and resistance of the substrate itself, and any further substances enclosed in the substrate in the case where the substrate is an open or enclosed container. Also provided are methods of manufacture and application for the disclosed composition.

### FIELD OF THE DISCLOSURE

The disclosure relates to a composition for externally coating a substrate with at least one hydroxyl group present on a surface thereof, such as glass and ceramic substrates to increase the thermal insulation and resistance of such substrate, in addition to manufacture and application methods thereof. The composition may be useful in blocking and delaying heat transfer between the external and internal faces of a flat or enclosed glass or ceramic substrate. A number of exemplary application cases are disclosed.

### BACKGROUND OF THE DISCLOSURE

Additive coatings on glass, ceramics, plastic, and metal substrates have been long used for improving certain properties of the substrate. Internal and external surface coatings have been investigated for glass and ceramic substrates, first for food and beverage containers, then later on automobile and building structure windows. The most recent advances in coatings have been in glass and ceramic containers containing pharmaceutical and therapeutic agents.

The majority of previously disclosures in the field of external coatings on glass and ceramic substrates have been for increasing the physical strength of the substrate, as demonstrated in drop, pressure, and delamination tests (see, e.g., U.S. Patent Application Publication No. 2013/0334089 and U.S. Pat. No. 6,451,432). Efforts have been invested into coating glass and ceramic substrates to produce more predictable fracture and rupture patterns upon breaking (see, e.g., U.S. Pat. No. 3,976,819). These types of coatings stabilize the glass or ceramic structural network during physical impact, but do not provide any stabilization of the glass or ceramic substrates against external fluctuations such as external temperature fluctuations.

Efforts in protecting the glass or ceramic substrate, as well as potential contents contained within, from exposure to ultraviolet (UV) light and/or direct sunlight have also been previously described. A few publications also provide details regarding protection against infrared (IR) heat transfer into the substrate and potential contents within. However, still lacking is an external coating on glass or ceramic substrate, especially in the case where the substrate is a container, for delaying or resisting heat transfer from an external source to the substrate's internalities. In addition, a number of existing UV- or sunlight-protective coatings are non-transparent, which restricts potential applications of such coating, especially for use in the medical transportation and storage space which often requires transparent glass or ceramic containers.

### BRIEF SUMMARY OF THE DISCLOSURE

According to one aspect, there is provided an external coating, based on substituted polysaccharides, for a substrate with free hydroxyl groups on a surface thereof, in one alternative, said substrate is selected from the group consisting of glass, ceramic and combinations thereof, for decreasing the rate of heat transfer through said substrate from thermal fluctuations in an external environment surrounding said substrate. In one alternative, conduction is the primary method of heat transfer addressed in this disclosure.

According to another aspect, there is provided a coating composition comprising: i) at least one sterol-substituted polysaccharide; ii) an inorganic matrix, in one alternative a plurality of inorganic matrices; and iii) at least one functionalized outer layer, in one alternative a plurality of functionalized outer layers, wherein said composition may be externally coated onto a substrate, in one alternative onto a glass or ceramic substrate, for delaying, in one alternative resisting heat transfer from an external surface of the substrate to an internal surface of the substrate and any contents contained within said substrate. In one alternative, said substrate is made of glass, ceramic and combinations thereof and may take on any shape, including but not limited to flat, curved, or shaped and may be an open or enclosed container.

According to yet another aspect, there is provided a composition to be applied to an external surface of a substrate, in sequential layers, to minimize heat transfer into the substrate, in one alternative, to minimize heat transfer into an inner surface of the substrate, and any contents contained within said substrate. The specifications described herein are one alternative general guidelines for producing the formulation described herein, while minor variations in the specific chemical composition and deposition of layers used may be made by persons skilled in the art for situations of unique application.

In one alternative, the first one or more layers, applied to the substrate surface, may comprise at least one inorganic and/or organic oxide that may be covalently bound to any free hydroxyl group or groups on the surface of the substrate, in one alternative on the surface of a substrate selected from the group consisting of glass, ceramic and combinations thereof, to modify (treat) the substrate surface. In one alternative, said at least one inorganic and/or organic oxide suitable for substrate surface modification comprises, but is not limited to, TiO₂, SiO₂, InSnO₂, ZnO, siloxane and combinations thereof. In another alternative, said substrate surface may be modified. The terms “modifying” and “modification” as used herein relate to functionalizing a substrate surface to better accommodate the attachment of a layer, in one alternative, a subsequent layer of at least one polysaccharide, a derivative thereof and combinations thereof onto the modified substrate surface. In one alternative said substrate is selected from glass, ceramic and combinations thereof.

In yet another alternative, the subsequent layer or layers composition comprises at least one polysaccharide, a derivative of said at least one polysaccharide and combinations thereof, said at least one polysaccharide selected from the group consisting of a monomeric, oligomeric, or polymeric polysaccharide, a derivative thereof, with or without a sterol-group substitution and/or a hydrocarbon group substitution, forming an inner layer. The at least one polysaccharide may be monomeric, polymeric and combinations thereof. In one alternative, the majority of said polysaccharide, in one alternative greater than 90% w/v (>90%), in the composition is polymeric. In another alternative, depending on the desired uniformity, concentration, and other physical attributes (such as but not limited to layer thickness, infrared (IR) spectra identifying groups present therein, light transmission (i.e. ultraviolet (UV) visibility) of the subsequent layer, in one alternative, the polysaccharide coating, the process applying a coating onto the substrate (the deposition process) of any single layer may be repeated several times. In one alternative, the inner layer is about 63% w/w of the overall coating. In another alternative, the inner layer comprises from about 6-8 mg/cm² of substrate surface area.

In yet another alternative, one or more sterol-groups may be substituted onto the at least one polysaccharide. In one alternative, the one or more sterol-group attachments are added onto the at least one polysaccharide of a penultimate layer to be applied to said substrate. In one alternative, said penultimate layer is positioned immediately interior to an outermost coating layer. In one alternative, said outermost coating layer is selected from the group consisting of a polishing, optically clear, anti-weathering, anti-scratch, anti-frictive, anti-microbial, anti-oxidation, anti-frost, anti-wetting, anti-cracking, functional and combinations thereof.

In one alternative, said sterol-substituted polysaccharide layer comprises (1) the same type of sterol group attached at one or multiple sites of a polysaccharide unit, or (2) the same type of sterol group attached at one or multiple sites of different polysaccharide units in a homogenous mixture, or (3) two or more different sterol groups attached at one or multiple sites of the same type of polysaccharide unit, or (4) two or more different sterol groups attached at one or multiple sites of different polysaccharide units in a homogenous mixture to form a single penultimate coating layer.

In yet another alternative, to further impart thermal insulation and thermal resistance characteristics onto the substrate, in some alternatives the modifying agent may be used again, in the form of a layer, to provide further enhancement of adherence between polysaccharide layers. The application sequence of one or more modifying layer(s) preceding one or more polysaccharide layer(s) may be repeated until a desired thickness, sequence combination of layers, or a number of other physical attributes have been achieved, such as but not limited to optical clarity, hardness, surface smoothness, anti-wetting and other attributes known to persons of skill in the art.

In yet another alternative, said outermost layer of the composition comprises a monomer, oligomer, or polymer of a hydrocarbon, anhydride, acrylic, urethane, or a derivative thereof, optionally with a modified side chain unit, functional unit and combinations thereof. The modified side chain unit and functional unit may be the alteration, addition, or reduction of single atoms, halogens, straight-chain or branched alkyl, alkenyl, alkynyl, aryl, alkoxy, aryloxy, aromatic, hydroxy, carboxy, carbamate, nitro, cyano, isocyano, thiocyano, isothiocyano, or azide groups to one or more repeating unit of the side chain or functional unit. With the intention of illustrating and not limiting the scope of this disclosure, examples of compounds that may comprise the outermost coating layer include polyurethane, polyvinyl, polylactic acids, polyethylene, at least one derivative thereof and combinations thereof. In one alternative, functionalization of the outermost layer may include, but not limited to, polishing, optically clear, anti-weathering, anti-scratch, anti-frictive, anti-microbial, anti-oxidation, anti-frost, anti-wetting, enhanced physical robustness, anti-cracking and combinations thereof.

In one alternative, the external coating process may or may not include all of the disclosed steps and/or may or may not be sequentially processed in the particular sequence discussed, and the presently disclosed manufacturing process and coating methods encompass any sequencing, overlap, or parallel processing of such steps. The various alternatives may be provided in any suitable combination with one another.

In one alternative, we have found that improvements in thermal insulation and thermal resistance provided by the present composition and deposition (application) methods are believed to stem from entrapment of fluids including, but not limited to, atmospheric air, which represents poor heat transfer media, inside and in-between large oligomeric and polymeric polysaccharides.

In another alternative, we have also found that evacuating the fluids entrapped therein resulting in voids in vacuum, also result in poor heat transfer.

In one alternative, applications of the disclosure include, but are not limited to, external coating of a primary packaging vial made of glass, ceramic and combinations thereof, for pharmaceutical and therapeutic packaging; external coating of a food-grade glass or ceramic bottle; external coating of a medical-grade glass or ceramic substrate surface; and the external coating of a glass or ceramic pane on vehicles or building structures.

In one alternative, there is provided a composition for externally coating a primary packaging bottle substrate for containment of at least one pharmaceutical or therapeutic agent, the thickness of each composition layer on said substrate, as well as the total overall thickness of the combined layers on said substrate, does not occlude the clear appearance of the substrate nor burden any other downstream processing steps (such as but not limited to sterilization (steam and autoclave and depyrogenation), mass production processes, filling, sealing, and other processing steps known to persons skilled in the art). In the pharmaceutical industry, a transparent external coating on a container vial is preferred to allow a physician or practitioner to easily visualize the state of the pharmaceutical or therapeutic agent within said container.

According to one alternative, there is provided a substrate coated with a multi-layered composition, wherein the multi-layered composition comprises:
(a) a modification layer disposed on a surface of the substrate, said modification layer comprising at least one inorganic and/or organic compound capable of binding free hydroxyl groups;
(b) an inner layer comprising
   (i) a fist layer comprising at least one monosaccharide or polysaccharide, optionally substituted with one or more sterol groups; and optionally
   (ii) a second layer comprising at least one inorganic oxide; and
(c) at least one outer layer disposed on said inner layer, said at least one outer layer comprising a monomer or polymer of a hydrocarbon, anhydride, urethane, acrylic, urethane, derivatives thereof and combinations thereof.

In one alternative, said substrate has free hydroxyl groups on a surface thereof.
In one alternative, the substrate is glass or ceramic.

In another alternative, the substrate is shaped as an open or closed container, such that the multi-layered composition is disposed on an external surface of the container.

In another alternative, the multi-layered composition comprises 1, 2, 3, or 4 inner layers.

In another alternative, the multi-layered composition comprises one modification layer, an inner layer comprising at least one monosaccharide or polysaccharide substituted with a sterol group, and an optional outer layer.

In another alternative, the modification layer comprises TiCl₄ and at least one inorganic oxide selected from the group consisting of TiO₂, SiO₂, InSnO₂, and ZnO.

In another alternative the modification layer comprise a first layer of TiCl₄ and a second layer comprising at least one inorganic oxide selected from the group consisting of TiO₂, SiO₂, InSnO₂, and ZnO.

In another alternative, the inorganic oxide is TiO₂.

In another alternative, the organic compound is siloxane.

In another alternative, the inner layer comprises a monosaccharide or polysaccharide substituted with one or more sterol groups selected from the group consisting of cholesterol, ergosterol, cortisol and combinations thereof.

In another alternative, the first layer of said inner layer comprises a pullulan or cellulose optionally substituted with one or more sterol groups.

In another alternative, the first layer of said inner layer comprises pullulan substituted with cholesterol or cellulose substituted with cholesterol.

In another alternative, the at least one outer layer comprises polyurethane, polyvinyl, polylactic acid, polyethylene, or a mixture thereof.

In another alternative, the at least one outer layer comprises polyurethane.

In another alternative, the polyurethane is a substituted branched polyurethane.

In another alternative, the substituted branched polyurethane is substituted with benzothiazole.

In another alternative, the substituted branched polyurethane substituted with benzothiazole has a degree of substitution of from 0% to about 10%.

In another alternative, the substituted branched polyurethane substituted with benzothiazole has a degree of substitution of 3%.

In another alternative, there is provided a coated substrate, coated with a multi-layered composition selected from the group consisting of:
(a) substrate-TiCl₄-(TiO₂)n-TiCl₄-(Cellulose)m-R;
(b) substrate-TiCl₄-(TiO₂)n-TiCl₄-(pullulan)x-R; and
(c) substrate-TiCl₄-(TiO₂)n-TiCl₄-(Cellulose)m-(TiO₂)y-(pullulan)x-R wherein:
   n, m, x, and y represent a number of coatings of each layer, and each of
   n, m, x, and y is independently an integer equal to or greater than 1; and R is the outer layer, wherein
   the outer layer comprises polyurethane, polyvinyl, polylactic acid, polyethylene, or a mixture thereof.

In another alternative, there is provided a method of coating a substrate as defined herein, the method comprising:
(a) coating the substrate with a composition comprising at least one inorganic and/or organic compound capable of at least one of
   i) binding free hydroxyl groups;
   ii) providing anionic functional groups;
      adding at least one inorganic and/or organic oxide layer thereto to form the modification layer; wherein in one alternative said at least one inorganic compound is TiCl₄;
(b) coating the substrate having the modification layer formed in step a) with a composition comprising at least one monosaccharide or polysaccharide optionally substituted with one or more sterol groups to form an inner layer; optionally followed by coating with a layer of TiO₂ wherein either both steps (a) and (b) is repeated one or more times; and
(c) coating the substrate formed in step (b) with a composition comprising a monomer or polymer of a hydrocarbon, anhydride, acrylic, urethane and combinations thereof, to form at least one outer layer, thereby obtaining the substrate coated with a multi-layered composition.

In another alternative, there is provided a method of improving thermal insulation or thermal resistance of a substrate, the method comprising providing a substrate coated with a multi-layered composition as described herein.

In one alternative, the substrate is shaped as an open or closed container such that the multi-layered composition is disposed on an external surface of the container.

In another alternative, there is provided a method of improving thermal insulation or thermal resistance of a substrate having free hydroxyl groups on a surface thereof, the method comprising coating a substrate with a multi-layered composition comprising:
(a) coating the substrate with a composition comprising at least one inorganic and/or organic compound capable of at least one of
   (i) binding free hydroxyl groups;
   (ii) providing anionic functional groups;
   (iii)

adding at least one inorganic and/or organic oxide layer thereto to form the modification layer disposed on said surface; wherein in one alternative said at least one inorganic compound is TiCl₄;
(b) coating the substrate having the modification layer formed in step a) with a composition comprising at least one monosaccharide or polysaccharide optionally substituted with one or more sterol groups to form an inner layer optionally followed by coating with a layer of TiO₂; wherein either of both steps (a) and (b) is repeated one or more times; and
(c) coating the substrate formed in step (b) with a composition comprising a monomer or polymer of a hydrocarbon, anhydride, acrylic, urethane and combinations thereof to form an outer layer, thereby obtaining the substrate coated with a multi-layered composition.

In another alternative, the substrate is shaped as open or closed container, such that the multi-layered composition is disposed on an external surface of the container.

In another alternative, there is provided a method of improving thermal insulation or thermal resistance of a substrate, the method comprising providing a substrate coated with a multi-layered composition as described herein.

In another alternative, the substrate is shaped as open or closed container, such that the multi-layered composition is disposed on an external surface of the container.

In one alternative, the inner layer has a thickness of about 3 μm to 1000 μm. In another alternative, the inner layer has a thickness of about 200 μm to 600 μm.

In another alternative, the outer layer has a thickness of about 1-40 μm. In another alternative, the outer layer has a thickness of about 1-10 μm.

In another alternative, there is provided a composition for coating an exterior surface of a substrate, said composition providing thermal insulation; said composition comprising:
(a) a modification layer disposed on a surface of the substrate, said modification layer comprising at least one inorganic and/or organic compound capable of binding free hydroxyl groups;
(b) at least one inner layer disposed on said modification layer, said at least one inner layer comprising:
   (i) a first layer comprising a monosaccharide or polysaccharide optionally substituted with one or more sterol groups; and
   (ii) optionally, a second layer comprising at least one inorganic oxide; and
(c) a least one outer layer disposed on said inner layer, said at least one outer layer comprising a monomer or polymer of a hydrocarbon, anhydride, acrylic, urethane, derivatives thereof and combinations thereof;
   wherein said substrate exterior surface of said substrate has at least one hydroxyl group present on the exterior surface thereof.

One of the objects of the present disclosure, is to provide an improved method of coating a container made of a substrate, in one alternative a glass, ceramic and combination thereof, to impart insulating properties to the glass or ceramic substrate for maintaining a temperature differential (in relation to the temperature of the environment surrounding the container), in one alternative to maintain the contents of said container at a temperature in the range of 0° to 10° C., in one alternative from about 2° to 8° C., for a longer time without changing aesthetics and functions of the container, for instance, by using a separate, external insulation sleeve, or label.

In one alternative, there is provided a method of coating a container made of a substrate to reduce the rate of heat transfer from the environment surrounding the exterior of the container to the interior of the container.

As used herein, the terms outermost layer, outermost coating layer and outermost functionalized/functional layer/coating are synonymous.

### BRIEF DESCRIPTION OF THE DRAWINGS

The disclosure, together with additional objects, features, advantages and aspects thereof, will be best understood from the following description, the appended claims and the accompanying drawings, in which:

FIGS. 1a-1b show a pictorial of a multi-layered composition according to an alternative, adhered onto the surface of a substrate, such as a window pane, pharmaceutical vial, etc.

FIG. 1c shows a pictorial of a multi-layered composition according to alternative without TiO₂ in between polysaccharide layers.

FIG. 2a-2b show a pictorial of a multi-layered composition according to an alternative, adhered onto the surface of a glass or ceramic substrate that is a container, such as a pharmaceutical vial, food-grade bottle, etc.

FIG. 3 shows an example of a polysaccharide, pullulan, that may be substituted with sterol groups and used to externally coat a glass or ceramic substrate as described herein.

FIG. 4 shows an example of a sterol unit, cholesterol, which may be attached onto a polysaccharide, such as cellulose or pullulan, for use in externally coating glass or ceramic substrates as described herein.

FIG. 5 shows a schematic of a polysaccharide unit adhered onto the surface of a glass or ceramic substrate, with metal oxides facilitating the connection as modifying agents, according to an alternative of the disclosure; used in this example is the priming metal oxide agent TiO₂, the first polysaccharide cellulose, and the second polysaccharide pullulan bearing sterol cholesterol groups.

FIG. 6 provides profilometry data on the polysaccharide coating according to one alternative.

FIG. 7 provides surface morphology of a coated and uncoated area of a glass surface substrate according to one alternative.

FIG. 8 provides infrared spectra data for a polyurethane suitable for an outermost coating according to one alternative.

FIG. 9 provides calorimetry data demonstrating superior thermal resistance of a coated glass bottle coated compared to an uncoated glass bottle.

FIG. 10 provides a Fourier-transform infrared spectroscopy of a polysaccharide inner layer according to one alternative.

FIG. 11 provides an Ultraviolet-visible spectroscopy of an outer functional (polyurethane) layer according to one alternative.

### DETAILED DESCRIPTION OF THE DISCLOSURE

The present disclosure will now be described more fully, with reference to the accompanying drawings, in which several alternatives are shown. This disclosure may be embodied in many different forms and should not be construed as limited to the alternatives set forth here.

Within the context of this application, the term “derivative” when used with respect to a monomer, oligomer, or polymer of a hydrocarbon, anhydride, acrylic or urethane means that the monomer, oligomer, or polymer of the hydrocarbon, anhydride, acrylic or urethane has at least one modification to the side chain groups and/or functional units. The at least one modification to the side chain group and/or functional units may be the alteration, addition, or reduction of single atoms, halogens, straight-chain or branched alkyl, alkenyl, alkynyl, aryl, alkoxy, aryloxy, aromatic, hydroxy, carboxy, nitro, cyano, isocyano, thiocyano, isothiocyano, or azide groups to one or more repeating units of the monomer, oligomer or polymer.

As used herein, the term “thermal insulation” means preventing thermal induction, reducing thermal induction, or delaying the transfer of thermal energy from the external environment into the internalities of the substrate.

As used herein, the term “thermal resistance” means the ability of a substrate to delay an increase in its internal temperature in the presence of external heat. According to one alternative of the disclosure, coating a substrate with a multi-layered composition as described herein increases the thermal resistance of the substrate.

As used herein, the term “pharmaceutical agent” means any active pharmaceutical ingredient known the art in view of the present disclosure. Preferably, a pharmaceutical agent is a biopharmaceutical agent. Biopharmaceutical agents are typically sensitive to heat and temperature fluctuations, e.g., temperature increases. Examples of biopharmaceutical agent include, but are not limited to, vaccines, monoclonal and recombinant-antibody drugs, genetic and cellular therapies, and other biologic drugs.

As used herein, the term “biocompatible” refers to a substance or material that is not harmful or toxic to living tissues, animals, etc.

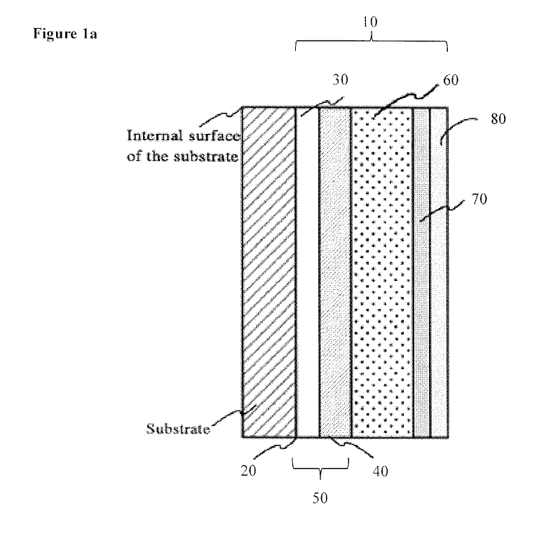

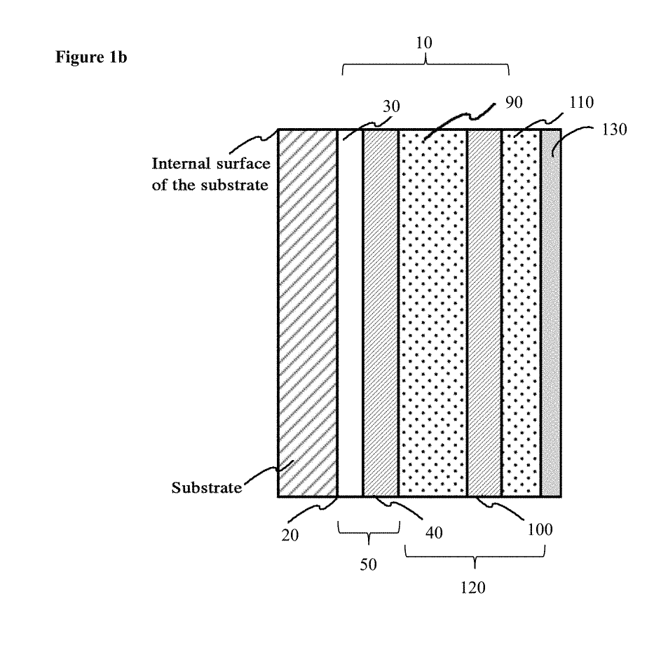

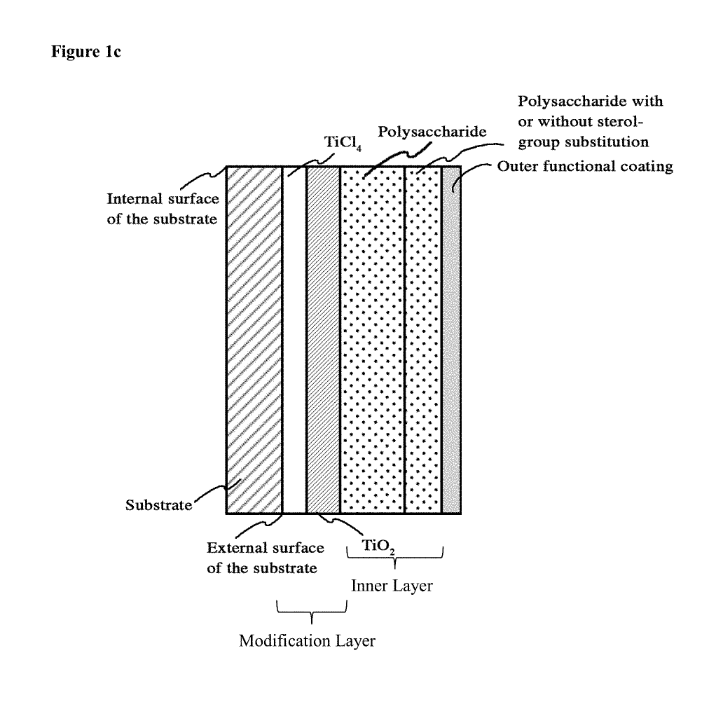

Referring now to FIG. 1a) there is shown a multi-layered composition 10 applied on an external surface of a substrate 20 modified with a first layer 30 of modifying agent TiCl₄ and a second layer 40 of modifying agent TiO₂ resulting in a modification layer 50, followed by a single layer comprising a polysaccharide, with or without sterol group substitutions forming an inner layer 60, with an outer functional coating 70 and an optional second outer functional coating layer 80.

FIG. 1b shows a multi-layered composition 10 applied on an external surface of a substrate 20 modified with a first layer 30 of a modifying agent TiCl₄ and a second layer 40 of modifying agent TiO₂ forming a modification layer 50, followed by one layer 90 of polysaccharide, with or without sterol group substitutions, followed by a layer 100 of modifying agent TiO₂ followed by a polysaccharide layer 110 with or without sterol-group substitution, forming an inner layer 120 and an outer functional coating layer 130. It is advantageous for the purposes of the disclosure to have the penultimate polysaccharide layer to be substituted with sterol-groups; in one alternative, the layer comprising the modifying agent as shown in FIG. 1a) is from about 0.01-3 μm thickness, in another alternative from about 0.1-0.5 μm thickness, and in another alternative, from about 2-3 μm thickness, depending on the number of layers deposited onto said substrate surface. The layer comprising the polysaccharide as shown in FIG. 1a) is 3-200 μm in thickness; and the outer functional layer as shown in FIG. 1a) has an overall thickness of 1-10 μm.

FIG. 1c is similar to FIG. 1b save for the lack of a TiO₂ layer between the polysccharide layers.

The disclosure relates to a multi-layered composition for coating an external surface of a substrate to provide thermal insulation to said substrate, and increase said substrate's thermal resistance against temperature fluctuations in the immediate external environment of said substrate. A “substrate” as used herein is any material bearing free hydroxyl (—OH) groups. In one alternative, said substrate is selected from the group consisting of glass, ceramic and combinations thereof. Additionally, in another alternative, the substrate may be flat, curved, or shaped as an open or closed container. A container may be any size or shape, and is not limited to any particular size or shape. In the case where the substrate is an open or closed container, the thermal insulation and resistance are also imparted onto any contents contained within the substrate. For the examples specified in this disclosure, borosilicate glass was used as the substrate.

In one alternative, the coating disclosed herein may comprise several layers during application (deposition) onto a substrate, to ameliorate adherence of said coating to said substrate and thermally insulating properties to the substrate and any contents enclosed within the substrate. The layers are described here by the sequential order of deposition, and provided with examples for the purpose of better narration without limiting the scope of this disclosure. It should be noted that the order, repeatability, and thickness of each layer used during deposition onto the substrate may be modified by those skilled in the art for unique application cases such as externally coating pharmaceutical grade glass containers for medical products.

The first layer (also known as the modification layer), as a part of the disclosed composition, may be applied to the external surface of the glass or ceramic substrate directly, or may be applied on top of an existing functional or non-functional coating layer or layers on the substrate, provided that such existing functional or non-functional coating layer or layers possesses free hydroxyl groups. This first layer comprises one or more inorganic and/or organic compounds that bind to the free hydroxyl groups on the external surface of the substrate, or an existing functional or non-functional coating layer, to improve the uniformity of the functional groups on the substrate surface on a molecular level, and to initiate the functionalization of the external face of the substrate or the pre-existing functional or non-functional coating layer. Examples of such inorganic and organic compounds include, but are not limited to TiCl₄. Further, the modification layer comprises at least one inorganic oxide selected from the group consisting of TiO₂, SiO₂, InSnO₂, and ZnO. Example of an organic compound includes, but is not limited to, siloxane. This modification layer may be applied by dissolving the inorganic compound in a solvent (such as a polar solvent) including but not limited to water, acetyl acetone, acetonitrile, ethanol and methanol, forming a modification solution or paste, then applying the modification solution or paste onto the substrate by any method known in the art, in view of the present disclosure, such as sputtering, vapor deposition, spraying, wiping (with a cloth containing the modification solution), dipping, powder deposition, electrostatic deposition, rolling, heat treatment, cold treatment, or other suitable techniques.

Aqueous or gaseous by-products may form during the application of the inorganic oxide (due to displacement of ions), which may require evaporation or drying by atmospheric air. Improvements of hydroxyl uniformity on the substrate surface or pre-existing coated layer may be accomplished by applying several coats of the inorganic oxide layer once a first coat is cured. Curing typically takes about 15 minutes. In one alternative, the application of said layer(s) do(es) not occlude the transparency of the substrate beyond the point required for its designated use. For example, in food or pharmaceutical containment applications, the transparency and appearance of the container or vial can be important.

In another alternative, the subsequent layer comprises a monomeric, oligomeric, or polymeric polysaccharide optionally substituted with one or more sterol groups. In one alternative, the polysaccharide is sterol substituted in the range of 0-30%. In another alternative, the polysaccharide is sterol substituted in the range of 1-5%. While monomeric polysaccharides may also be used, in one alternative, more than 90% w/v of the polysaccharides used in the disclosed composition are oligomeric or polymeric, and are preferably polymeric. In one alternative, multimeric polysaccharides are preferred primarily for two reasons: the first being most polysaccharides are produced and supplied in the form of multimers, and the second being multimeric networks of polysaccharides are generally of lower density and have more pores that can entrap gases, which are poor heat conductors. Examples of saccharides that may be used include, but are not limited to, glucose, fructose, galactose, maltose, dextrose, pullulan, sucrose, lactose, cellulose, and trehalose. This subsequent layer may be applied by dissolving the saccharide in a solvent forming a solution or paste, then applying the solution or paste onto the substrate by any method known in the art in view of the present disclosure, such as sputtering, vapor deposition, spraying, dipping, powder deposition, electrostatic deposition, or other suitable techniques. Aqueous or gaseous by-products may form during the displacement reaction, which may require evaporation or drying by atmospheric air. This layer provides thermal insulation and thermal resistance to the surface of the substrate and any contents enclosed by the substrate. The extent of thermal insulation and thermal resistance offered by this coating layer may be enhanced by repeatedly applying several times. In one alternative, the application of said layer(s) do(es) not occlude the transparency of the substrate beyond the point required for its designated use.

Following application of the saccharide layer, there is an option to subsequently coat the substrate with an outermost functional layer, or to repeat the initial functionalization step where hydroxyl groups are modified to better accommodate further saccharide coatings. In the case where an outermost functional coating layer is desired, a monomer, oligomer, or polymer of a hydrocarbon, anhydride, acrylic, urethane or a derivative of any of these with optionally modified side chain units or functional units may be used for the purpose of providing at least one specialized function to the substrate and its externally coated layer(s). Such at least one specialized function may be, but is not limited to, polishing, optically clear, anti-weathering, anti-scratch, anti-frictive, anti-microbial, anti-oxidation, anti-frost, anti-wetting, anti-cracking and combinations thereof. Examples of compounds that may be used include, but are not limited to, polyurethane, polyvinyl, polyethylene, and mixtures or hybrids or derivatives thereof. Such specialized functional layers are known to those skilled in the art. The use of these functional layers is listed here because it is complementary to the saccharide-based coating layers disclosed.

In one alternative, in the case where a polysaccharide coating layer is the penultimate layer, a sterol-group substitution may be desired on the polysaccharide units. One or more sterol-group attachments may be added onto the polysaccharides, in one of the following formats: (1) the same type of sterol molecule attached one or multiple times onto the same polysaccharide unit, or (2) the same type of sterol molecule attached one or multiple times onto different polysaccharide units in a homogenous mixture, or (3) two or more different sterol molecules attached one or multiple times onto the same type of polysaccharide unit, or (4) two or more different sterol molecule attached one or multiple times onto different polysaccharide units in a homogenous mixture to form a single coating layer. In one alternative, using sterol-substituted polysaccharides in the penultimate layer comes from the hydrophobicity offered by the polysaccharide's sterol-substitutions. Toward the outer layers of an externally coated glass or ceramic substrate, hydrophobicity is desired to decrease interaction of the coating with water or moisture in the atmosphere, and therefore elongate the shelf-life of the contents within the substrate. Examples of sterol-substituted polysaccharides, by way of example and not as to limit the scope of this disclosure, include cholesterol-bearing pullulan and cholesterol-bearing cellulose and combinations thereof. Other examples of sterol groups that may be used include, but are not limited to, cholesterol, ergosterol, cortisol and combinations thereof.

In one alternative, the external coating process may or may not include all of the disclosed steps or be sequentially processed in the particular sequence discussed, and the presently disclosed manufacturing process and coating methods encompass any sequencing, overlap, or parallel processing of such steps. The various alternatives may be provided in any suitable combination with one another. While the coating layers are described in the present disclosure, for clarity of understanding, as adjacent layers overlying one another sequentially, one or more of the coatings may seep into or combine with one or more of the other coatings that it is in direct contact with, and the layers as described are not necessarily discrete layers once coated on a substrate.

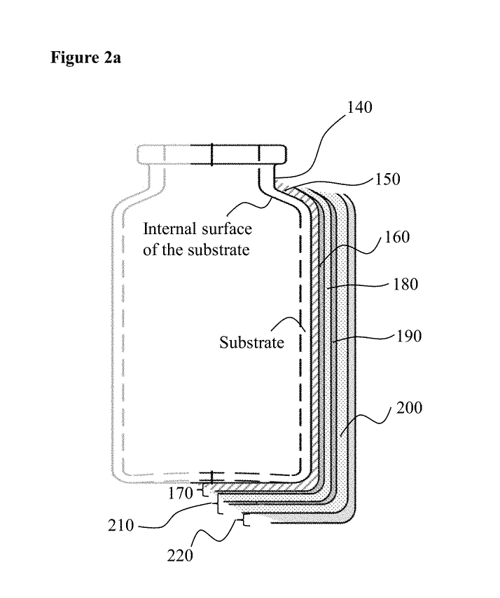

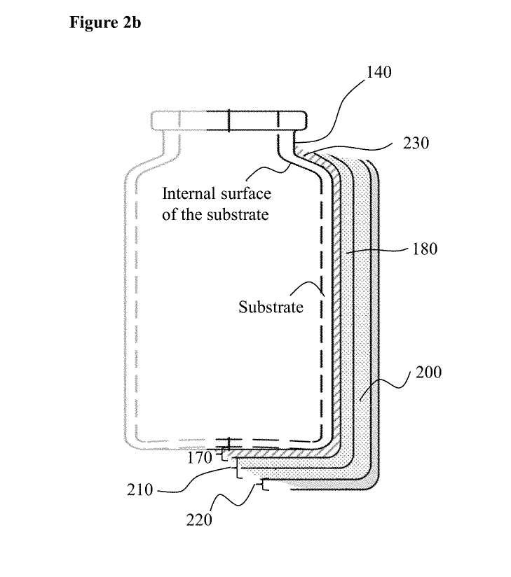

Referring now to FIG. 2a), there is shown a plurality of layers as applied to an external surface (or face) of a glass container 140. In this alternative, the external surface is first coated with a layer 150 containing TiCl₄, followed by a layer 160 containing TiO₂ resulting in the formation of a modification layer 170. This is followed by a layer 180 containing polysaccharide followed by another layer 190 containing TiO₂ followed by a layer 200 containing polysaccharide (with or without sterol-group substitution) forming an inner layer 210, and finally a polyurethane layer forming an outer functional layer (or coating) 220.

Referring now to FIG. 2b) there is show a composition similar to FIG. 2a) save for the lack of TiO₂ layers in between the polysaccharide layers (inner layer) and the modification layer comprises siloxane 230.

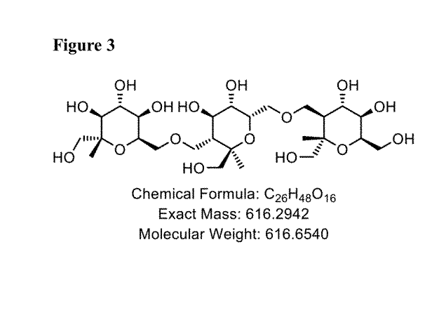

Referring now to FIG. 3, there is shown pullulan as an example of a polysaccharide as per the disclosure.

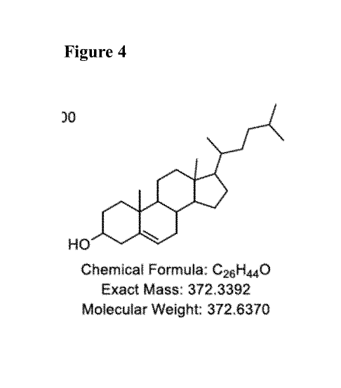

Referring now to FIG. 4, there is shown cholesterol as an example of a sterol unit as per the disclosure.

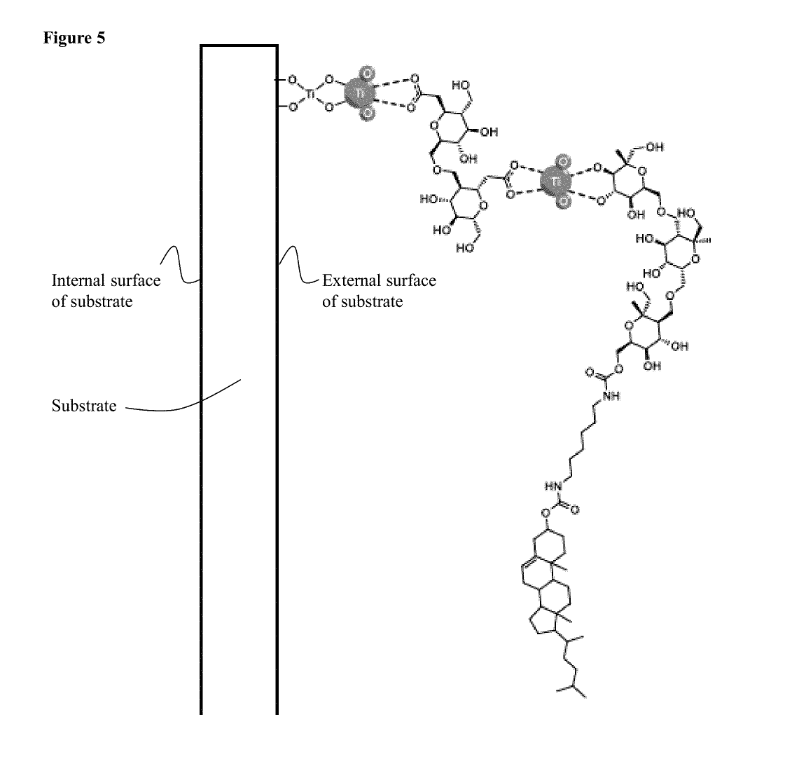

Referring now to FIG. 5, there is shown the external face (surface) of a substrate with a polysaccharide unit adhered onto the surface of the substrate, with metal oxides facilitating the connection as modifying agents. In this Figure, there is seen the priming metal oxide agent TiO₂, the first polysaccharide cellulose, and the second polysaccharide pullulan bearing sterol cholesterol groups.

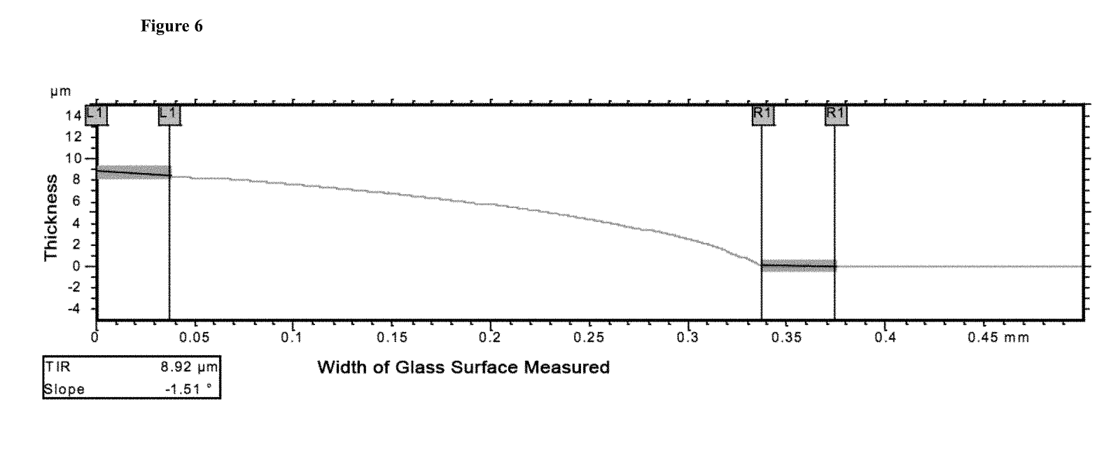

Referring now to FIG. 6, there is shown profilometry data on a glass substrate with a modification layer followed by a polysaccharide coating. As best seen here, the surface morphology at the edge of a single coating with an average thickness (TIR) of 8.92 μm. As best seen here, section L1-L1 identifies the start of uniform thickness of the coated glass substrate. Area R1-R1 identifies an area of untreated glass surface. As further shown in the FIG. 6, the slope of −1.51° provides a metric to determine concentration of solution coating applied and provides a measurement to choose concentration based on requirements of coating.

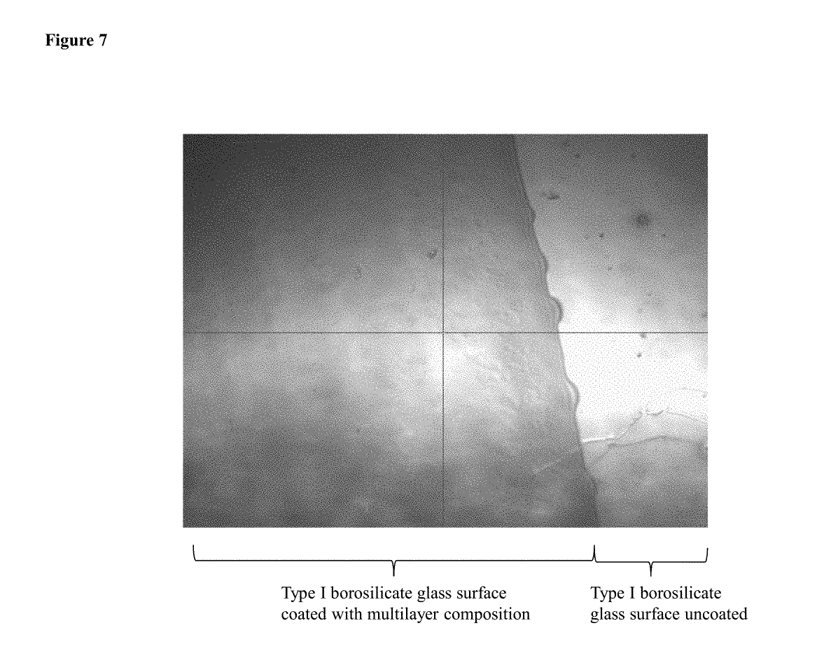

Referring now to FIG. 7, there is shown a microscopic image of borosilicate type 1, laboratory grade (ThermoFisher, US) glass surface with the darker area being coated with a multi-layer composition described herein and the lighter area (parts of the upper and lower right quadrants) not coated as it relates to the profilometry of FIG. 6.

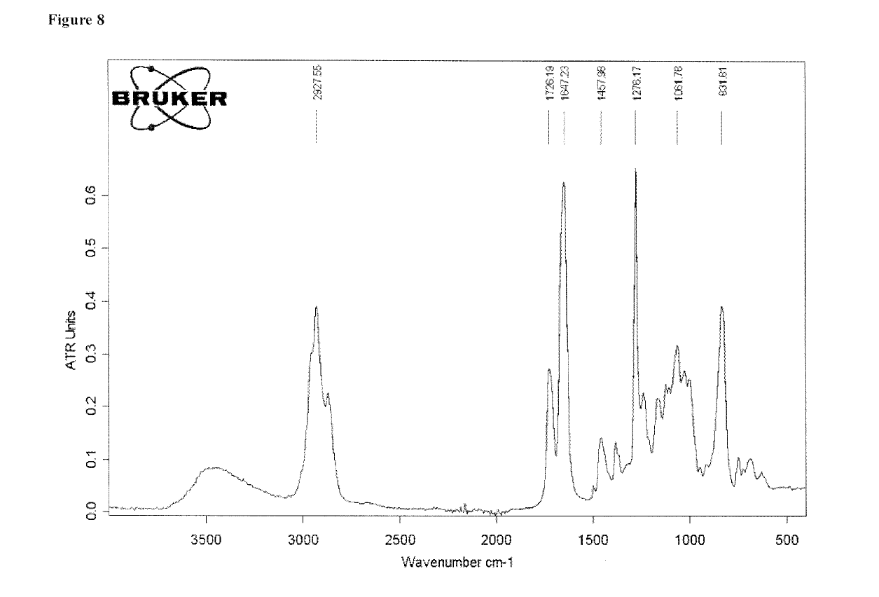

Referring now to FIG. 8, there is shown an infrared spectra of a polyurethane (branched polyurethane substituted with a benzothiazole with a substitution degree of 3%) useful as an outermost coating (layer) to enhance the physical robustness and anti-moisture properties of the overall coating on the substrate.

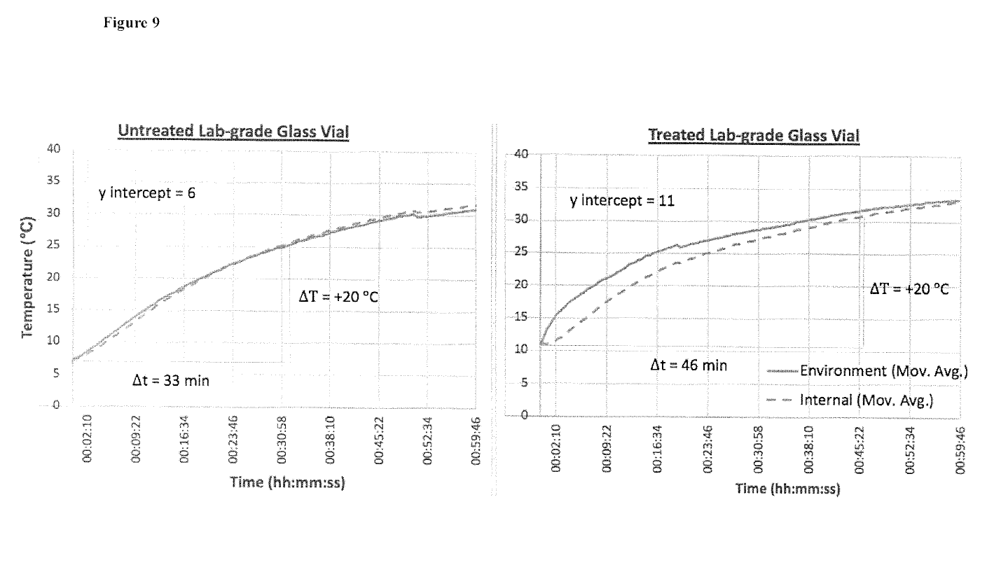

Referring now to FIG. 9, there is shown calorimetry data of a coated (treated) glass bottle as per Example 2 versus an uncoated (untreated) glass bottle (8 mm clear glass screw top sampler vial, ThermoFisher, US). As may be seen by the data, the heat transfer is delayed with the coated glass bottle versus the uncoated glass bottle. Both vials of the same substrate and content were removed from a cool environment and placed in an environment where heat is slowly increased (endpoint at 35° C.) for 1 h12 m. Throughout the time period, a two-probe digital thermometer was used to measure the respective temperatures of the external environment of the glass bottles and the internal contents of the coated (Treated) or uncoated (Untreated) bottles at 10 s intervals. The moving averages taken from 3 consecutive temperature readings result in FIG. 9. As seen in FIG. 9, the surface coating allows for a delay in the thermal energy transfer between the external environment into the internal content of the coated bottle.

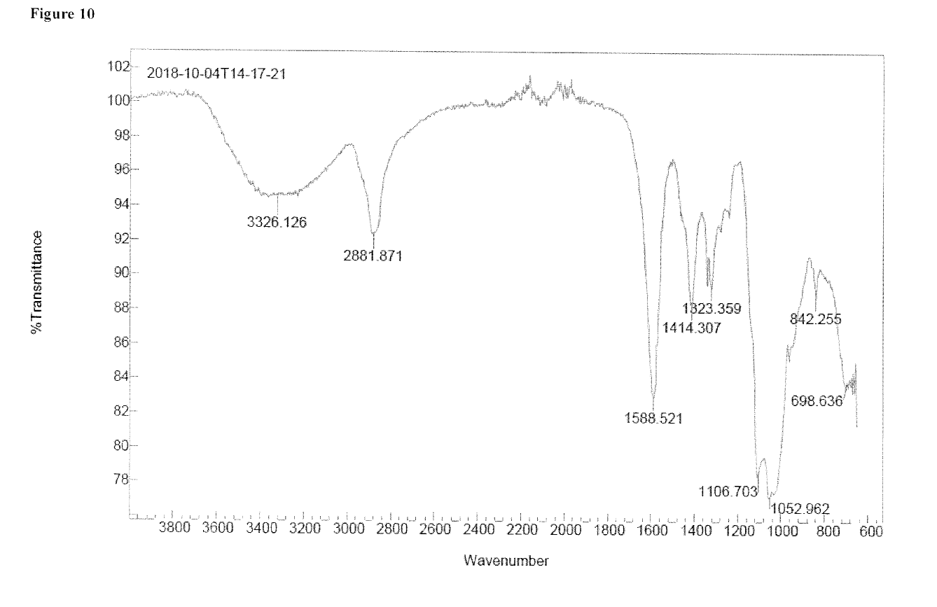

Referring now to FIG. 10, there is depicted a FTIR spectroscopy of a polysaccharide inner layer of a 10-30% alkyl-substituted carboxymethyl cellulose derivative without sterol substitution.

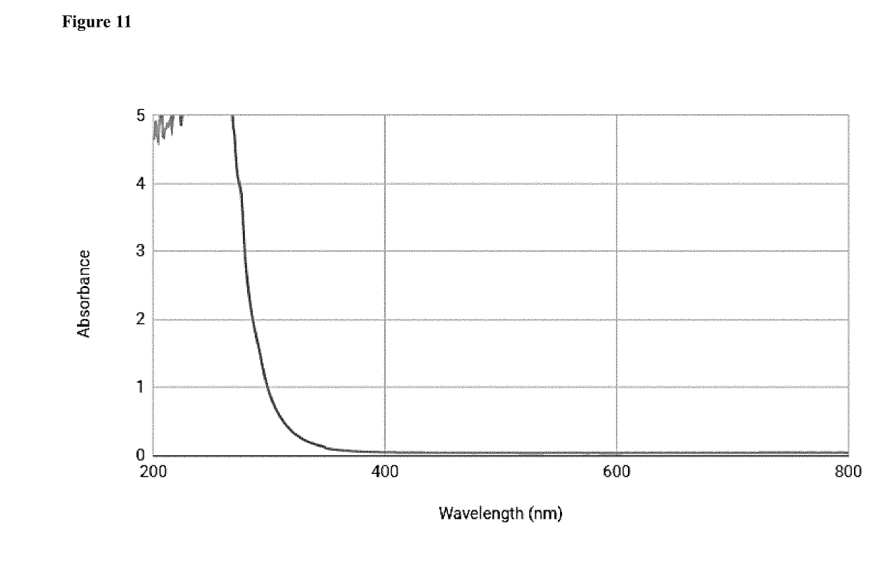

Referring now to FIG. 11, there is depicted a UV-Vis spectroscopy of an outer layer of a branched polyurethane with benzothiazole-substitutions with 3% degree of substitution. This is an example of an outer layer for coating pharmaceutical containers as it is transparent (no absorbance within the visible spectrum between 400-800 nm).

According to alternatives of the disclosure, coating an external surface of a substrate, such as an open or closed container, with a multi-layered composition of the disclosure may be used to provide thermal insulation to the substrate as well as to the contents of the container.

### EXAMPLES

With the sole intention of illustrating certain principles and practices of the disclosure, and by no way limiting the scope of the disclosure, we provide here example compositions that may be used to externally coat a pharmaceutical glass vial for thermal insulation.

### Example 1

### Coating Pharmaceutical Grade Borosilicate Glass Vials

Six identical pharmaceutical grade borosilicate glass vials were coated by multiple layers. The exteriors of the vials were dipped in an 0.05 M aqueous solution of TiCl₄ for 2 hours at 70° C., upon removal from the aqueous solution, excess solution on the vials were dried by atmospheric air at room temperature for 15 minutes Immediately following this, the vials were slowly lowered (0.1 cm/s) into an aqueous solution of titanium tetraisopropoxide (TTIP) (1:3 molar ratio), acetyl acetone (1:1 v/v), 1-propanol (1:1 v/v), 0.1 M nitric acid (6:1 v/v), Triton X-100 (1:100 v/v) and PEG 3000 (1:100 v/v) to form the TiO₂ layer. The vials were exposed to the TTIP solution for 2 hours at 70° C. The vials coated with the TiO₂ layer (modification layer) were annealed at 450° C. for 15 minutes. The TTIP dip coating and annealing process may be repeated several times to increase the thickness of the modification layer. In this example, the entire modification layer (TiO₂ and TiCl₄) possessed a total thickness in the range of 2.3-3 μm as produced by dipping the vial 4 times (each vial was dipped subsequent to annealing of the previous deposition) . Upon cooling, the vials were then slowly dipped (2 cm/s) in an aqueous solution of polymeric pullulan (MW=50,000-90,000 g/mol with average approx. 75,000 g/mol; 0.00375% w/v). at 50° C. for 2 hours. Once air-dried, the vials were heated to 120° C. for 2 hours to evaporate any remaining solvent.

### Example 2

### Coating a Pharmaceutical Grade Borosilicate Glass Vial

A pharmaceutical grade borosilicate glass vial was coated separated into multiple layers, each layer comprising of a portion of the components. The vials were dipped in an 0.05M aqueous solution of TiCl₄ for 2 hours at 70° C., with the excess solution dried by atmospheric air at room temperature. Immediately following this, the vials were slowly lowered (0.1 cm/s) into an aqueous solution of titanium tetraisopropoxide (TTIP) (1:3 molar ratio), acetyl acetone (1:1 v/v), 1-propanol (1:1 v/v) and 0.1 M nitric acid (6:1 v/v) to form the initial TiO₂ layer. Triton X-100 (1:10 v/v) and PEG 3000 (1:100 v/v) were later added to further modify the structure of this TiO₂ layer. The vials were coated for 2 hours at 65° C. The TiO₂ layer were annealed at 450° C. for 15 minutes. This dip coating process can be repeated several times to increase the thickness of the coating. The vials were then slowly dipped (2 cm/s) in an aqueous solution of sodium carboxymethyl cellulose (MW=200, 000-300,000 g/mol with average approx. 250,000 g/mol, 1.2 degree of substitution) at 50° C. for 2 hours. Once air-dried, the vials were heated to 120° C. for 2 hours to evaporate remaining solvents.

In particular alternatives of the disclosure, a substrate, such as a glass substrate, is coated with layers according to one of the following:
1. Substrate-TiCl₄-(TiO₂)ₙ—TiCl₄-(Cellulose)ₘ-Outer functional layer
2. Substrate-TiCl₄-(TiO₂)ₙ—TiCl₄-(Pullulan)ₓ-Outer functional layer
3. Substrate-TiCl₄-(TiO₂)ₙTiCl₄-(Cellulose)ₘ—(TiO₂)_{y}-(Pullulan)ₓ-Outer functional layer

where n, m, x, and y represent a number of coatings of each of the layers, and each of n, m, x, and y is independently an integer equal to or greater than 1.

In the annealing process in which TiO₂ is heated to 450° C. for 15 minutes, cracks within the TiO₂ layer may form. A second treatment of TiCl₄ may fix these cracks by filling in the space resulting from the cracks within the TiO₂ layer. This allows for a more even surface coating.

### Example 3

### Coating a Single Surface of a Flat Borosilicate Glass

A flat piece of borosilicate glass was coated with multiple layers. The vials were dipped in 5% w/v siloxane solution in 1:2 acetone: water solution for 30 seconds as the modification layer, followed by a slow wiping motion with a microfiber cloth at ambient temperature to remove excess solution on the surface. The glass was then coated with a uniform layer of carboxymethyl cellulose bearing polyethylene glycol branches (MW=200,000-300,000 g/mol, 1%w/v aqueous solution) via electrospray ionization (in this example 35 ml of solution is used in 100 depositions). This cellulose solution cures by exposure to air for 2 hours, by evaporating the solvent. To ensure the uniformity and desired thickness of more than 40 μm, the electrospray process is repeated 3 times, each time after the previous deposition has been fully cured. After this inner layer is fully cured, a polyurethane outer coating (30% w/v) is brushed on to the surface lightly to create a thin layer, and cured using moist air for 45 minutes at room temperature.

In particular alternatives, a substrate, such as a glass substrate, is coated with layers according to one of the following:
1. Substrate-Pre-modification layer-(polyethylene glycol-bearing Cellulose)ₘ-Outer functional layer where m represent a number of coatings applied for the modified cellulose layer, and is an integer between 1 to 5 (preferably 3).

### Example 4

### Coating a Pharmaceutical Grade Borosilicate Glass Vial

A borosilicate glass vial was coated with separated into multiple layers. In this example, the modifying layer is omitted. The glass vial was lowered into a solution of carboxymethyl cellulose bearing polyethylene glycol branches (MW=200,000-300,000 g/mol, 1%w/v aqueous solution) with a lowering vertical movement speed of 0.1 cm/s. After 2 minutes in the solution, the glass vial was raised from the solution at the same vertical speed. This cellulose coating was cured by exposure to air for 2 hours at room temperature, by evaporating the solvent. To ensure the uniformity and desired thickness of more than 40 μm, the dipping process is repeated 2 times. After this inner layer is fully cured, the vial is then lowered (0.1 cm/s) into a polyurethane outer coating solution (10% w/v), upon complete submersion, the vial was removed from the solution and cured using moist air (5% water) in an incubator for 45 minutes at room temperature. To provide enhanced robustness to the coating composition, this outer coating application was repeated once more.

In particular alternatives, a substrate, such as a glass substrate, is coated with layers according to one of the following:
1. Substrate-(polyethylene glycol-bearing Cellulose)ₘ-Outer functional layerₙ where m represents a number of coatings applied for the modified cellulose inner layer, and is an integer between 1 to 5 (preferably 3); where n represents a number of coatings applied for the polyurethane outer layer, and is an integer between 1 to 2 (preferably 2).

We claim:

1. A substrate coated with a multi-layered composition, wherein the multi-layered composition comprises:
(a) a modification layer disposed on a surface of the substrate, said modification layer comprising at least one inorganic and/or organic compound capable of binding free hydroxyl groups;
(b) at least one inner layer disposed on said modification layer, said at least one inner layer comprising:
(i) a first layer comprising at least one monosaccharide or polysaccharide optionally substituted with one or more sterol groups; and
(ii) optionally, a second layer comprising at least one inorganic oxide; and
(c) a least one outer layer disposed on said inner layer, said at least one outer layer comprising a monomer or polymer of a hydrocarbon, anhydride, acrylic, urethane, derivatives thereof and combinations thereof.

2. The substrate of claim 1, wherein the substrate has free hydroxyl groups on a surface thereof.

3. The substrate of claim 2, wherein the substrate is glass or ceramic.

4. The substrate of claim 1, wherein the substrate is shaped as an open or closed container, such that the multi-layered composition is disposed on an external surface of the open or closed container.

5. The substrate of claim 1, where the multi-layered composition comprises 1, 2, 3, or 4 inner layers.

6. The substrate of claim 1, wherein the multi-layered composition comprises one modification layer, one inner layer comprising at least one monosaccharide or polysaccharide substituted with a sterol group, and an optional outer layer.

7. The substrate of claim 1, wherein the modification layer comprises TiCl₄.

8. The substrate of claim 7, wherein the modification layer further comprises at least one inorganic oxide selected from the group consisting of TiO₂, SiO₂, InSnO₂, and ZnO.

9. The substrate of claim 1 wherein the optional second layer of the inner layer comprises at least one inorganic oxide selected from the group consisting of TiO₂, SiO₂, InSnO₂, and ZnO.

10. The substrate of claim 9, wherein the inorganic oxide is TiO₂.

11. The substrate of claim 1 wherein said organic compound is siloxane.

12. The substrate of claim 1, wherein the first layer of the inner layer comprises a monosaccharide or polysaccharide substituted with one or more sterol groups selected from the group consisting of cholesterol, ergosterol, cortisol and combinations thereof.

13. The substrate of claim 1, wherein the first layer of the inner layer comprises a pullulan or cellulose optionally substituted with one or more sterol groups.

14. The substrate of claim 1, wherein the first layer of the inner layer comprises pullulan substituted with cholesterol or cellulose substituted with cholesterol.

15. The substrate of claim 1, wherein the at least one outer layer comprises polyurethane, polyvinyl, polylactic acid, or polyethylene, or a mixture thereof.

16. The substrate of claim 15, wherein the at least one outer layer comprises polyurethane.

17. The substrate of claim 15, wherein the polyurethane is a substituted branched poylurethane.

18. The substrate of claim 17, wherein the substituted branch polyurethane is a branched polyurethane substituted with a benzothiazole.

19. The substrate of claim 18 wherein the branched polyurethane substituted with a benzothiazole has a substitution degree of from about 0% to about 10%.

20. The substrate of claim 19 wherein the substitution degree is 3%.

21. A coated substrate, coated with a multi-layered composition selected from the group consisting of:
(a) substrate-TiCl₄-(TiO₂)ₙ—TiCl₄-(Cellulose)ₘ-R;
(b) substrate-TiCl₄-(TiO₂)ₙ—TiCl₄-(pullulan)ₓ-R; and
(c) substrate-TiCl₄-(TiO₂)ₙ—TiCl₄-(Cellulose)ₘ-(TiO₂)_{y}-(pullulan)ₓ-R wherein:
n, m, x, and y represent a number of coatings of each layer, and each of n, m, x, and y is independently an integer equal to or greater than 1; and R is an outer layer, wherein the outer layer comprises polyurethane, polyvinyl, polylactic acid, or polyethylene, or a mixture thereof.

22. A method of preparing the substrate of claim 1, the method comprising:
(a) coating the substrate with a composition comprising at least one inorganic and/or organic compound capable of at least one of
i) binding free hydroxyl groups;
ii) provide anionic functional groups;
to form the modification layer;
(b) coating the substrate having the modification layer formed in step (a) with a composition comprising at least one monosaccharide or polysaccharide optionally substituted with one or more sterol groups to form the inner layer, optionally followed by a layer of TiO₂ wherein either or both steps (a) and (b) is repeated one or more times; and
(c) coating the substrate formed in step (b) with a composition comprising a monomer or polymer of a hydrocarbon, anhydride, acrylic, urethane and combinations thereof to form the at least one outer layer,
thereby obtaining the substrate coated with a multi-layered composition.

23. A method of improving thermal insulation or thermal resistance of a substrate, the method comprising providing a substrate coated with a multi-layered composition according to claim 1.

24. The method of claim 22, wherein the substrate is shaped as an open or closed container such that the multi-layered composition is disposed on an external surface of the open or closed container.

25. A method of improving thermal insulation or thermal resistance of a substrate, having free hydroxyl groups on a surface thereof, the method comprising coating a substrate with a multi-layered composition comprising:
(a) coating the substrate with a composition comprising at least one inorganic and/or organic compound capable of binding free hydroxyl groups of said substrate to form a modification layer disposed on the substrate;
(b) coating the substrate having the modification layer formed in step (a) with a composition comprising at least one monosaccharide or polysaccharide optionally substituted with one or more sterol groups optionally followed by a layer comprising TiO₂ to form an inner layer, wherein either or both steps (a) and (b) is repeated one or more times; and
(c) coating the substrate formed in step (b) with a composition comprising a monomer or polymer of a hydrocarbon, anhydride, acrylic, urethane, derivative thereof and combinations thereof to form an outer layer.

26. The method of claim 25, wherein the substrate is shaped as open or closed container, such that the multi-layered composition is disposed on an external surface of the open or closed container.

27. A method of improving thermal insulation or thermal resistance of a substrate, the method comprising providing a substrate coated with a multi-layered composition according to claim 20.

28. The method of claim 27, wherein the substrate is shaped as open or closed container, such that the multi-layered composition is disposed on an external surface of the open or closed container.

29. The substrate of claim 1, wherein the inner layer has a thickness of about 3 μm to 1000 μm.

30. The substrate of claim 1, wherein the inner layer has a thickness of about 200 μm to 600 μm.

31. The substrate of claim 1 wherein the outer layer has a thickness of about 1-40 μm.

32. The substrate of claim 1 wherein the outer layer has a thickness of about 1-10 μm.

33. A composition for coating an exterior surface of a substrate, said composition providing thermal insulation; said composition comprising:
(a) a modification layer disposed on a surface of the substrate, said modification layer comprising at least one inorganic and/or organic compound capable of binding free hydroxyl groups;
(b) at least one inner layer disposed on said modification layer, said at least one inner layer comprising:
(iii) a first layer comprising a monosaccharide or polysaccharide optionally substituted with one or more sterol groups; and
(iv) optionally, a second layer comprising at least one inorganic oxide; and
(c) at least one outer layer disposed on said inner layer, said at least one outer layer comprising a monomer or polymer of a hydrocarbon, anhydride, acrylic, urethane, derivatives thereof and combinations thereof;
wherein said substrate exterior surface of said substrate has at least one hydroxyl group present on the exterior surface thereof.

34. The composition of claim 33, where the composition comprises 1, 2, 3, or 4 inner layers.

35. The composition of claim 33, wherein the composition comprises one modification layer, one inner layer comprising at least one monosaccharide or polysaccharide substituted with a sterol group, and an optional outer layer.

36. The composition of claim 33, wherein the modification layer comprises TiCl₄.

37. The composition of claim 33, wherein the modification layer further comprises at least one inorganic oxide selected from the group consisting of TiO2, SiO2, InSnO2, and ZnO.

38. The composition of claim 33, wherein the optional second layer of the inner layer comprises at least one inorganic oxide selected from the group consisting of TiO2, SiO2, InSnO2, and ZnO.

39. The composition of claim 33, wherein the inorganic oxide is TiO2.

40. The composition of claim 33 wherein said organic compound is siloxane.

41. The composition of claim 33, wherein the first layer of the inner layer comprises a monosaccharide or polysaccharide substituted with one or more sterol groups selected from the group consisting of cholesterol, ergosterol, cortisol and combinations thereof.

42. The composition of claim 33, wherein the first layer of the inner layer comprises a pullulan or cellulose optionally substituted with one or more sterol groups.

43. The composition of claim 33, wherein the first layer of the inner layer comprises pullulan substituted with cholesterol or cellulose substituted with cholesterol.

44. The composition of claim 33, wherein the at least one outer layer comprises polyurethane, polyvinyl, polylactic acid, or polyethylene, or a mixture thereof.

45. The composition of claim 33, wherein the at least one outer layer comprises polyurethane.

46. The composition of claim 45, wherein the polyurethane is a substituted branched polyurethane.

47. The composition of claim 46, wherein the substituted branch polyurethane is a branched polyurethane substituted with a benzothiazole.

48. The composition of claim 47, wherein the branched polyurethane substituted with a benzothiazole has a substitution degree of from about 0% to about 10%.

49. The composition of claim 48 wherein the substitution degree is 3%.

50. The substrate of claim 1 wherein the polysaccharide has a degree of sterol substitution from 0-30%.

51. The substrate of claim 1 wherein the polysaccharide has a degree of sterol substitution from 1-5%.

52. The coated substrate of claim 21 wherein the polysaccharide has a degree of sterol substitution from 0-30%.

53. The coated substrate of claim 21 wherein the polysaccharide has a degree of sterol substitution from 1-5%.

54. The method of claim 22, wherein the polysaccharide has a degree of sterol substitution from 0-30%.

55. The method of claim 22, wherein the polysaccharide has a degree of sterol substitution of from 1-5%.

56. The composition of claim 33, wherein the polysaccharide has a degree of sterol substitution from 0-30%.

57. The composition of claim 33, wherein the polysaccharide has a degree of sterol substitution of from 1-5%.
